(19) United States
(12) Patent Application Publication
(10) Pub. No.: US 2015/0339941 A1
(43) Pub. Date: Nov. 26, 2015

(54) SYSTEM AND METHOD FOR AUTONOMIC SOCIAL LEARNING

(71) Applicant: Fan Lu, Richmond Hill (CA)

(72) Inventor: Fan Lu, Richmond Hill (CA)

(21) Appl. No.: 14/282,005

(22) Filed: May 20, 2014

(51) Int. Cl. G09B 7/04; G09B 5/06; G09B 5/12; G06F 17/30

(52) U.S. Cl. CPC G09B 7/04; G06F 17/30289; G06F 17/3053; G09B 5/065; G09B 5/12

(57) ABSTRACT

According to embodiments described in the specification, systems and methods are provided for autonomic social learning. A method in a server includes maintaining a first database with a plurality of content items, each content item associated with one or more contribution factors and a quality score; maintaining a second database with a plurality of learning records, each learning record corresponding to an achievement profile of a learner; receiving from an electronic device an electronic request for a selection of content items for a learner; filtering the plurality of content items based on the one or more contribution factors and the quality score; sending the selected, filtered content items to the electronic device for presentation on a display of the electronic device; receiving, from the electronic device, input associated with the selected, filtered and displayed content items; and adjusting the quality score associated with the content item, responsive to the received input.

### FIELD OF TECHNOLOGY

The present disclosure relates to computer-guided learning. Certain embodiments provide a system and method for autonomic social learning.

### BACKGROUND

Various techniques have been developed for computer-guided learning. Past approaches, including those using interactive learning programs, can suffer from several disadvantages, including that such approaches may not be tailored to the individual learner or they may not deliver learning content targeted to address the specific difficulties faced by the learner, having regard to peer learners that have mastered the same content. Traditional methods of tutoring learners have involved manual selection of content items designed to assist a learner; such methods can be subjective, unreliable and reflect inconsistent opinions or advice.

Improvements in systems and methods for computer-guided learning are desirable, including those for autonomic social learning.

The foregoing examples of the related art and limitations related thereto are intended to be illustrative and not exclusive. Other limitations of the related art will become apparent to those of skill in the art upon a reading of the specification and a review of the drawings.

### BRIEF DESCRIPTION OF THE DRAWINGS

Examples are illustrated with reference to the attached drawings. It is intended that the examples and figures disclosed herein be considered illustrative rather than restrictive.

FIG. 1 is a block diagram of a system for autonomic social learning in accordance with an example;

FIG. 2 is a block diagram of the logical components of the system of FIG. 1; and

FIG. 3 is a flowchart illustrating a method for autonomic social learning in accordance with an example.

### DETAILED DESCRIPTION

The following describes a computer-implemented method in a server having a processor, a memory, and a network interface device comprising the steps of: maintaining, in the memory, a first database with a plurality of content items, each content item associated with one or more contribution factors and a quality score; maintaining, in the memory, a second database with a plurality of learning records, each learning record corresponding to an achievement profile of a learner; receiving, from an electronic device, an electronic request for a selection of content items for a learner; filtering the plurality of content items based on the one or more contribution factors and the quality score; sending the selected, filtered content items to the electronic device for presentation on a display of the electronic device; receiving, from the electronic device, input associated with the selected, filtered and displayed content items; and adjusting the quality score associated with the content item, responsive to the received input.

Throughout the following description, specific details are set forth in order to provide a more thorough understanding to persons skilled in the art. However, well-known elements may not be shown or described in detail to avoid unnecessarily obscuring of the disclosure. Accordingly, the description and drawings are to be regarded in an illustrative, rather than a restrictive, sense.

This disclosure relates generally to computer-guided learning and particularly to systems and methods for autonomic social learning.

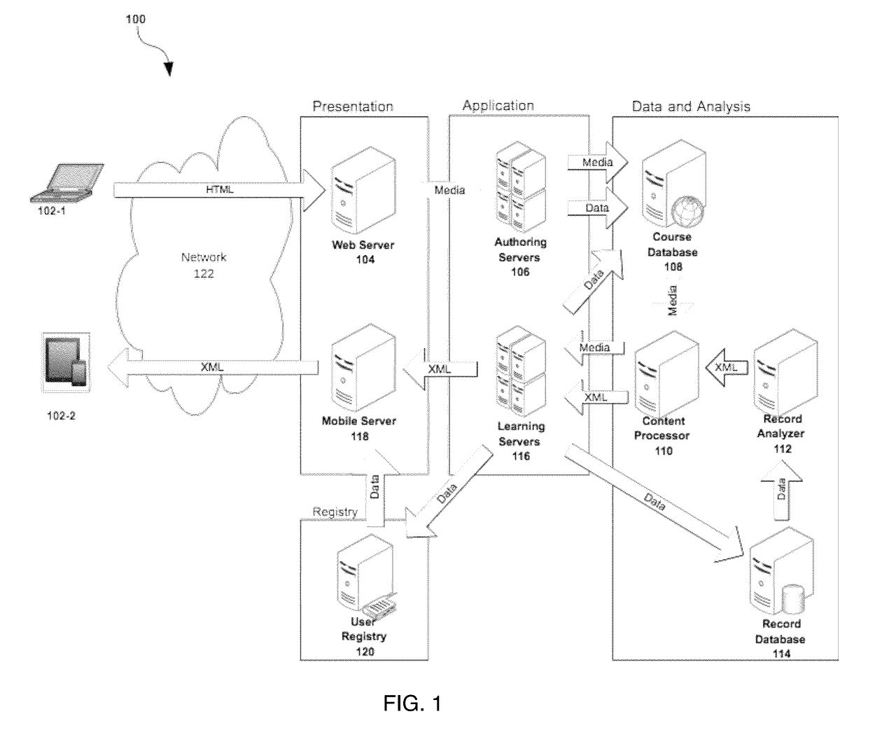

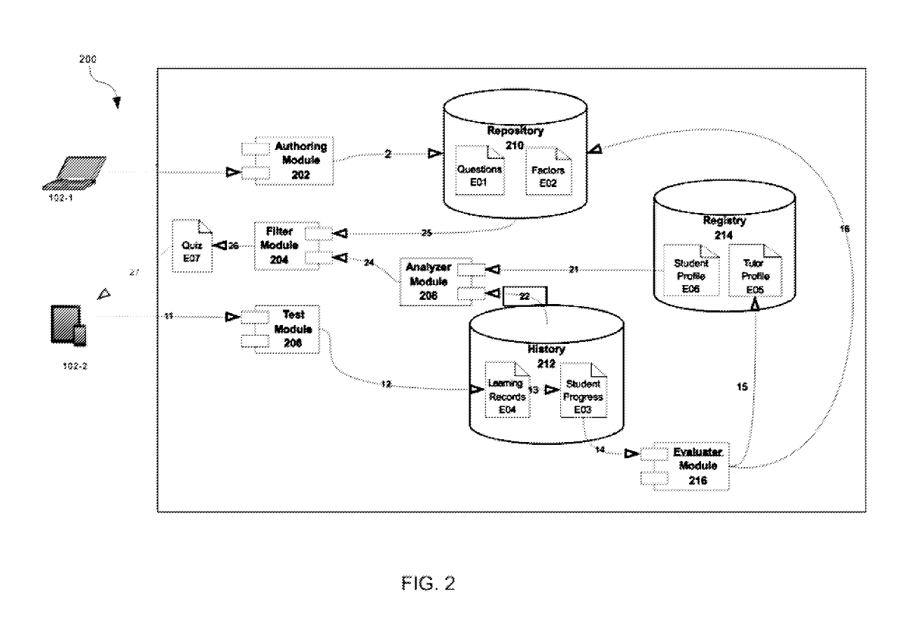

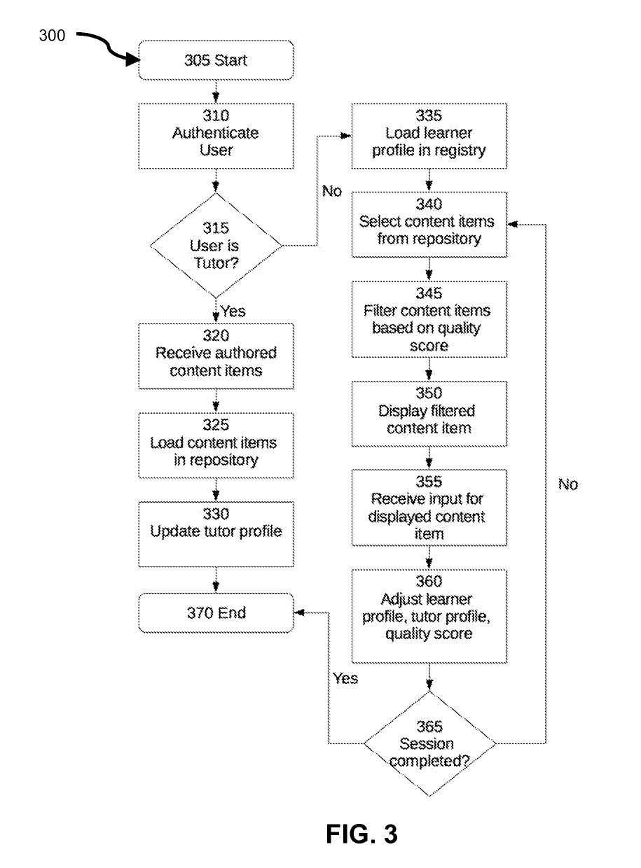

The following description provides, with reference to FIG. 1 and FIG. 2, detailed descriptions of exemplary systems for autonomic social learning. Detailed descriptions of corresponding computer-implemented methods are provided in connection with FIG. 3.

A block diagram of an example of a system 100 for autonomic social learning is shown in FIG. 1. According to this example, the system 100 includes one or more electronic devices 102-1, 102-2, etc. (generically referred to herein as “electronic device 102” and collectively as “electronic devices 102”), all of which are connected to a web server 104 (or a mobile server 118, or both) via a network 122 such as the Internet.

Typically, the electronic devices 102 are associated with users who provide input for response from the web server 104 and/or mobile server 118. For example, the users can be tutors and/or learners (e.g., students) who create and/or consume content items (e.g., learning content).

Each electronic device 102 can be any of a desktop computer, smart phone, laptop computer, tablet computer, and the like. The electronic device 102 can include one or more processors, a memory, input and output devices (typically including a display, a speaker, a microphone, a camera, and other sensors), and a network interface device as described below in connection with the web server 104.

The electronic device 102 can exchange messages with the web server 104 via the network 122 using a client application 152 (not shown in FIG. 1) loaded on the electronic device 102. In one example, the client application 152 can be a web browser or mobile application that uses a web-based or mobile interface, respectively, and that exchanges messages with the web server 104 including content items.

The web server 104 is typically a server or mainframe within a housing containing an arrangement of one or more processors, volatile memory (i.e., random access memory or RAM), persistent memory (e.g., hard disk or solid state devices), and a network interface device (to allow the web server 104 to communicate over the network 122) interconnected by a bus. Many computing environments implementing the web server 104 or components thereof are within the scope of the invention. The server 104 can include a pair (or more) of servers for redundancy or load-balancing purposes, connected via the network 122 (e.g., an intranet or across the Internet) (not shown). The web server 104 can be connected to other computing infrastructure including displays, printers, data warehouse or file servers, and the like. The web server 104 can include a keyboard, mouse, touch-sensitive display (or other input devices), a monitor (or display, such as a touch-sensitive display, or other output devices) (not shown in FIG. 1).

The web server 104 includes a network interface device interconnected with the processor that allows the web server 104 to communicate with other computing devices such as the electronic devices 102 via a link with the network 122, or via a direct, local connection (such as a Universal Serial Bus (USB), Bluetooth™′ AirPlay™ connection, not shown). The network 122 can include any suitable combination of wired and/or wireless networks, including but not limited to a Wide Area Network (WAN) such as the Internet, a Local Area Network (LAN), HSPA/EVDO/LTE cell phone networks, WiFi networks, and the like.

The network interface device is selected for compatibility with the network 122, as well as with local links as desired. In one example, the link between the network interface device and the network is a wired link, such as an Ethernet link. The network interface device thus includes the necessary hardware for communicating over such a link. In other examples, the link between the web server 104 and the network 122 can be wireless, and the network interface device can include (in addition to, or instead of, any wired-link hardware) one or more transmitter/receiver assemblies, or radios, and associated circuitry.

The web server 104 stores, in the memory, a plurality of computer readable instructions executable by the processor. These instructions can include an operating system and a variety of applications. Among the applications in the memory is an application 150 (not shown in FIG. 1). When the processor executes the instructions of the application 150, the processor is configured to perform various functions specified by the computer readable instructions of the application 150, as will be discussed below in greater detail.

The system 100 typically includes additional servers, each of which can be configured like the web server 104, for carrying out specific functions of the system 100 described further herein. For example, the system 100 can include a mobile server 118, an authoring server 106, a learning server 116, a content processor (server) 110, a record analyzer (server) 112, among others. Multiple server instances can be created depending on the load of the authoring server 106, learning server 116, etc. According to one example, all functions of these servers can be performed by a single server, if desired. In one example, the function of the web server 104 can be performed by the electronic device 102.

The system 100 can include a course database 108 and a record database 114. The course database 108 maintains one or more electronic records representing content items, as discussed below. The record database 114 maintains one or more electronic records representing one or more learner's history, described below with reference to 212. According to one example, all functions of these databases can be performed by a single database, if desired. The databases can be loaded on the electronic device 102, in one example. Each of the course database 108 and the record database 114 can be a database application loaded on the web server 104, a stand-alone database server or a virtual machine in communication with the network interface device of the web server 104, or any other suitable database.

In operation, a tutor can use the client application 152 loaded on the electronic device 102-1 to exchange messages with the web server 104. The web server 104 can authenticate the electronic device 102-1 or its user by querying a user registry 120. The user registry 120 is a database that maintains user identifiers and login credentials. The user registry 120 is used to authenticate users accessing the web server 104. The electronic device 102-1 can exchange messages with the authoring server 106 to upload content items to be maintained in the course database 108.

In operation, a learner uses the client application 152 loaded on the electronic device 102-2 to communicate with the mobile server 118, in one example. Similarly, the mobile server 118 can authenticate the electronic device 102-2 (and its user) by querying the user registry 120. The electronic device 102-2 can then exchange messages (in XML format, for example) with the learning server 116 to download content items maintained in the course database 108 for presentation to the user within the client application 152.

According to one example, the selection of content items downloaded to the electronic device 102-2 can depend on filtering criteria generated by a record analyzer 112. The filtering criteria are generated based on the learning records of the user and his or her peers based on weighted contribution factors, described in more detail below. The filtering criteria are applied by the content processor 110. The content processor 110 queries the course database 108 for content items and then applies the filtering criteria. The content processor 110 forwards the filtered content items to the learning server 116 for presentation within the client application 152 of the electronic device 102-2.

When executed, the client application 152 that is loaded on the electronic device 102-2 renders the content items on a display of the electronic device 102-2, and receives input from the electronic device 102-2. The input is updated in the record database 114. Each content item in the course database 108 is assigned a quality score based on the input, described in more detail below.

Turning now to FIG. 2, a block diagram of the logical components of the system of FIG. 1 is shown. Table 1 compares the logical components with the associated physical components.

TABLE 1
Logical Component Deployment Table

| Logical | Reference | Corresponding Physical |
|---|---|---|
| Component Name | No. | Component |
| Authoring Module | 202 | 104 and/or 118 |
| Filter Module | 204 | 110 |
| Test Module | 206 | 116 |
| Analyzer Module | 208 | 112 |
| Evaluator Module | 216 | 116 and 118 |
| Repository | 210 | 108 |
| History | 212 | 114 |
| Registry | 214 | 120 |

According to one example, three non-limiting usage cases are realized by system 100 (illustrated as system 200 in FIG. 2) described herein:

### Usage Case #1: Tutor Creates Questions and Assigns Contribution Factors

The tutor uses the client application 152 on the electronic device 102-1 to access content items that have been authored by the authoring module 202 (shown as questions E01 in FIG. 2). The authoring module 202 is a server-based application/tool for tutors to create/update/delete content items representing learning materials. Each question E01 (also referred to as learning challenge in this specification) is assigned one or more contribution factors (shown as factors E02 in FIG. 2). The repository 210 is populated with content items (e.g., questions E01 representing learning materials or activities) with tutor's subjective claimed contributions to learners' learning advancements. For example, the tutor/author of a given content item (representing learning material) makes a claim as to their contribution factors and their weights when creating the learning material. In one example, the total weight is 10 and the tutor/author needs to allocate the weight to top 3 contribution factors with weight value of 5, 3, 2. The contribution factors and weights determine the filtering criteria discussed above.

### Usage Case #2: Learners Take Computer-Guided Test and Record Results to Enable Evaluation of Content Items and Tutors.

Once a content item is presented to a learner on the electronic device 102-2, a test module 206 is invoked to receive input from the electronic device 102-2 (e.g. permitting the user to answer a question associated with a content item). The input is then stored in a history database 212 as a learning record E04, described in more detail below. Learning records E04 are used to generate learner progress data E03. Learner progress data E03 are computed periodically based on the correctness and duration summary of the learner's answer, comparing with his/her peers of the same area and/or same curriculum.

### Usage Case #3: System Recommends Content Items Based on all Learners' Learning Records E04 and Content Item's Evaluation Results.

A learning filter is generated based on: 1) the learner's learning target (extracted from the learner profile E06 maintained in the registry 214). For example, a learning target is to reach 80% percentile of all learners in the same subject; 2) the learner's current status (extracted from a learner progress record E03 maintained in the history database 212; and 3) learner's learning records E04.

The analyzer module 218 calculates a learner's learning gap by evaluating learner profile E06 and learner progress E03. In one example, a learning gap is the percentile differences between learner's current status compared to his/her peers and/or the target he/she set for him/herself. The analyzer module 218 considers the records of other learners to identify how peer learners closed the learning gap and the associated content items associated with closing the gap.

For each content item (e.g., question E01), contribution factors and a quality score are calculated and are provided as input to the filter module 204, along with contribution factor E02 and associated quality score.

The filter module 204 uses these inputs to select one or more content items for presentation on the electronic device 102-1. A selection algorithm matches the contribution factors E02 to questions E01 and promotes content items (questions E01) having a higher quality score. An example of quality score calculation is described below. Generally, the selection algorithm can first choose a subset of content items with a higher quality score and then choose content items with best matching contribution factors within the subset.

### Contribution Factors

The factors E02 are subject-specific contributors assigned to a question E01. The value of each factor is assigned either by the system 100 or by the electronic device 102-2 operated by a tutor. The values of these factors E02 represent claimed effects on a learner's learning. The following is a sample table for geometry subject-specific factors.

| Factors (Sample) | Value Range (Sample) |
|---|---|
| Dimension concept | 0 to 10 |
| Dimension concept | 0 to 10 |
| Area concept | 0 to 10 |
| Volume concept | 0 to 10 |
| Polygons concept | 0 to 10 |
| Circles calculation | 0 to 10 |
| Shapes varieties | 0 to 10 |
| Similarities perception | 0 to 10 |
| Transformation concept | 0 to 10 |

Further to this example, each content item (question) has a record similar to the following table associates with it:

| | Contribution Factors | | | |
|---|---|---|---|---|
| Content | Subject: Geometry | | | |
| Item | Dimension | Shapes | Similarities | . . . |
| [Content | 4 | 8 | 9 | |
| Item ID] | | | | |

### Learning Records E04

A learning record E04 is a measurement of a learner's input in association with a content item (e.g., question). The following is a learning record E04 according to one example:

| | | Value Range |
|---|---|---|
| Question | Measurements | (Sample) |
| [Question | Correctness | 0 to 100 (Score) |
| ID] | Duration | 0 to 300 (Seconds) |

For each content item, the system 100 can collect learning records E04 from a plurality of learners. Each learning record E04 can contain a content identifier, a learner identifier, and values representing the correctness and the duration (in time) the learner took to provide input in relation to the content item (e.g., to answer the question). The following is a learning record E04 according to another example:

| Content | | Results | |
|---|---|---|---|
| Item | Learner | Correctness | Duration |
| identifier | identifier | (Score) | (Seconds) |
| [Content | [Learner ID #1] | 60 | 26 |
| Item ID] | [Learner ID #2] | 90 | 84 |
| | [Learner ID #3] | 80 | 78 |
| | . . . | . . . | . . . |

### Historical Record Summary

For each learner, the relationships between learning records E04 and an accumulated summary of the contribution factors of the content items can be recorded in a chronicled incremental manner. The following table illustrates a learning record E04 with added contribution factors according to a yet further example:

| | Results | | | | | | |
|---|---|---|---|---|---|---|---|
| | Average | | Contribution Factor Summary (Geometry) | | | | |
| | Correct- | Dura- | Dimen- | | | | |
| Number of | ness | tion | sion | Shape | Area | Volume | |
| Questions | vs. | vs. | Concept | Concept | Concept | Concept | |
| Completed | Target | Target | Sum | Sum | Sum | Sum | . . . |
| 10 | 51% | 1.23 | 60 | 70 | 56 | 81 | |
| 25 | 65% | 1.09 | 130 | 120 | 119 | 140 | |
| 39 | 88% | 0.91 | 220 | 230 | 240 | 233 | |
| . . . | . . . | . . . | . . . | . . . | . . . | . . . | . . . |

### Analysis Algorithm

For each problematic answer from a learner, the system 100 presents the next content item based on the historical records of large number of learners. In one example, a first step selects learners who provided correct input in association with one particular content item, for example, top X learners ranked by correctness and duration. A second step serializes the identified learners' learning record summaries. The following table illustrates a summary:

A third step ranks and weighs one or more contribution factors correlated with the learners' success in providing input associated with the content item. One way to implement the ranking is to calculating each factor's co-variances (CV) value, for instance:

### CV Transform Concept=2.5

### CV Function Concept=1.8

### CV Shape Concept=1.2

A fourth step searches the repository 210 for content items for which a tutor

| | | Ranking | | Factor Summary | | | | |
|---|---|---|---|---|---|---|---|---|
| | | Correctness | Duration | Dimension | Shape | Functions | Transform | |
| Learner | | vs | vs | Concept | Concept | Concept | Concept | |
| ID | Ranking | Target | Target | Sum | Sum | Sum | Sum | . . . |
| Learner A | 1 | 90% | 1.13 | 600 | 700 | 560 | 381 | |
| Learner B | 2 | 80% | 0.81 | 1300 | 120 | 119 | 540 | |
| Learner C | 3 | 70% | 0.62 | 900 | 530 | 240 | 233 | |
| . . . | . . . | . . . | . . . | . . . | . . . | . . . | . . . | |
| Learner X | X\| | 50% | 1.75 | 1100 | 235 | 456 | 122 | |

assigned contribution factor values matching the CV values mentioned above (transformation may need to align the value ranges). When multiple content items are returned by a search, content items with a higher quality score (explained below) can be selected.

### Quality Score

A quality score represent the effectiveness of a content item's contributions to a learner's progress. In operation, a content item is recommended to a learner based on the top learner's learning history. The quality score is increased with respect to all content items the learner had studied before (for example, within a certain timeframe). Advantageously, use of the method disclosed herein can identify and reward the most effective content items having the highest quality score. Thereby, a natural ranking for content items is generated.

| | | | | | | | Positive |
|---|---|---|---|---|---|---|---|
| Learner ID | | Historical Questions Studied | | | | | Adjustments |
| Learner #1 | Q135 | Q352 | Q358 | . . . | . . . | Q245 | +100 |
| Learner #2 | Q145 | Q252 | Q556 | . . . | . . . | Q867 | +99 |
| Learner #3 | Q835 | Q372 | Q155 | . . . | . . . | Q442 | +98 |
| Learner #4 | Q334 | Q852 | Q656 | . . . | . . . | Q571 | +97 |
| . . . | | | | | | | |
| Learner #100 | Q338 | Q259 | Q956 | . . . | . . . | Q635 | +1 |

A quality score increase can be recorded against a tutor to reward (or incent) the tutor's precision in estimating the claimed effect, or benefit, of the content item upon the learner's progress.

A flowchart illustrating an example of a disclosed method of autonomic social learning is shown in FIG. 3. This method can be carried out by the applications 150 and/or 152 or other software executed by, for example, the processor of the web server 104. The method can contain additional or fewer processes than shown and/or described, and can be performed in a different order. Computer-readable code executable by at least one processor of the web server 104 to perform the method can be stored in a computer-readable storage medium, such as a non-transitory computer-readable medium.

With reference to FIG. 3, a method 300 starts at 305 and, at 310, the web server 104 is configured to authenticate a user, such as a learner or a tutor. At 315, the web server 104 determines that the user is a tutor. At 320, the web server 104 receives authored content items from the electronic device 102, along with associated contribution factors and weights. The content items and associated data are loaded in the repository 210 at 325. The tutor's profile is updated at 330 and the method ends at 370. Alternatively, at 315, the web server 104 determines the user is a learner and, at 335, loads the learner's profile from the user registry 120. At 340, the system selects content items (learning challenges) from the repository 210 for presentation to the user on the electronic device 102. At 345, the content items are filtered based on a quality score. At 350, the filtered content items are displayed on the electronic device 102. At 355, the web server 104 receives input (e.g. a response to the learning challenge) responsive to the displayed content item. At 360, the system analyzes the response and adjusts the learner profile, the tutor profile, and the quality score associated with the content item. The adjustments that occur are described above and can include: recording the learner's progress, analyzing whether the content item is correlated with the learner's performance, and adjusting the tutor's reward profile upwards or downwards in recognition of the correlation. At 365, the session is completed once all selected, filtered content items have been presented to the user for response. At 370, the method ends.

Advantageously, the methods and systems described herein utilize at least two feedback cycles. Firstly, a learner's activities on the electronic device 102-1 can be analyzed; gaps can be addressed by consulting the entire learning community for recommended content items based on identified contribution factors and weights. Secondly, a tutor's authored content items can be scored and ranked based on the learner's progress, permitting relevant and targeted learning content to be presented. A self-sustained, self-improving and autonomous learning environment does not require (or can reduce the need for) manual selection of content items based on subject expertise. Rather, learners engaged in the systems and methods disclosed herein can benefit from peer learner experiences with the content items, and from the autonomic, closed loop feedback system provided by the disclosed techniques.

A computer-implemented method in a server having a processor, a memory, and a network interface device comprises the steps of maintaining, in the memory, a first database with a plurality of content items, each content item associated with one or more contribution factors and a quality score; maintaining, in the memory, a second database with a plurality of learning records, each learning record corresponding to an achievement profile of a learner; receiving, from an electronic device, an electronic request for a selection of content items for a learner; filtering the plurality of content items based on the one or more contribution factors and the quality score; sending the selected, filtered content items to the electronic device for presentation on a display of the electronic device; receiving, from the electronic device, input associated with the selected, filtered and displayed content items; adjusting the quality score associated with the content item, responsive to the received input.

The method can include adjusting the contribution factor associated with the content item, responsive to the received input.

The electronic device can be associated with a learning record in the second database. According to this example, the method can include adjusting the learning record, responsive to the received input.

The plurality of content items can include a plurality of learning challenge and the input can include a response to the learning challenge.

Optionally, the method includes receiving, from a tutor electronic device, one or more content items. Each content item can be associated with pre-populated contribution factors and a pre-populated quality score for loading into the first database.

The method can also include analyzing the response to the learning challenge to generate an actual contribution factor; comparing the actual contribution factor to a nominal contribution factor; and populating a tutor profile with a reward data value when the actual contribution factor exceeds the nominal contribution factor.

The content item can include multimedia elements.

Each of the contribution factors can be assigned a relative weight, and the filtering can be based on the contribution factors and the relative weight.

The quality score can be adjusted based on the receipt of input from a plurality of peer electronic devices. The adjusting of the quality score from the plurality of peer electronic devices can be autonomic. The filtering step can recommend content items based on the quality score and tailored to the learning record of the learner.

The electronic device can be a desktop computer, a smart phone, a laptop computer, or a tablet computer.

A system includes a server having a processor and connected to a network interface device and a memory. The processor can be configured to maintain, in the memory, a first database with a plurality of content items, each content item associated with one or more contribution factors and a quality score; maintain, in the memory, a second database with a plurality of learning records, each learning record corresponding to an achievement profile of a learner; receive, from an electronic device, an electronic request for a selection of content items for a learner; filter the plurality of content items based on the one or more contribution factors and the quality score; send the selected, filtered content items to the electronic device for presentation on a display of the electronic device; receive, from the electronic device, input associated with the selected, filtered and displayed content items; and adjust the quality score associated with the content item, responsive to the received input.

While a number of exemplary aspects and examples have been discussed above, those of skill in the art will recognize certain modifications, permutations, additions and sub-combinations thereof.

1. A computer-implemented method in a server having a processor, a memory, and a network interface device comprising the steps of:
maintaining, in the memory, a first database with a plurality of content items, each content item associated with one or more contribution factors and a quality score;
maintaining, in the memory, a second database with a plurality of learning records, each learning record corresponding to an achievement profile of a learner;
receiving, from an electronic device, an electronic request for a selection of content items for a learner;
filtering the plurality of content items based on the one or more contribution factors and the quality score;
sending the selected, filtered content items to the electronic device for presentation on a display of the electronic device;
receiving, from the electronic device, input associated with the selected, filtered and displayed content items;
adjusting the quality score associated with the content item, responsive to the received input.

2. The method of claim 1 further comprising:
adjusting the one or more contribution factors associated with one of the plurality of content items, responsive to the received input.

3. The method of claim 1 wherein the electronic device is associated with a learning record in the second database, the method further comprising:
adjusting the learning record, responsive to the received input.

4. The method of claim 1 wherein the plurality of content items comprise a plurality of learning challenges and wherein the input comprises a response to one of the plurality of learning challenges.

5. The method of claim 4 further comprising:
receiving, from a tutor electronic device, one or more content items, each content item associated with pre-populated contribution factors and a pre-populated quality score for loading into the first database.

6. The method of claim 5 further comprising:
analyzing the response to the learning challenge to generate an actual contribution factor;
comparing the actual contribution factor to a nominal contribution factor;
populating a tutor profile with a reward data value when the actual contribution factor exceeds the nominal contribution factor.

7. The method of claim 1 wherein the content item comprises multimedia elements.

8. The method of claim 1 wherein each of the contribution factors is assigned a relative weight, and the filtering is based on the contribution factors and the relative weight.

9. The method of claim 1 wherein the quality score is adjusted based on the receipt of input from a plurality of peer electronic devices.

10. The method of claim 9 wherein the adjusting of the quality score from the plurality of peer electronic devices is autonomic and the filtering recommends content items based on the quality score and tailored to the learning record of the learner.

11. The method of claim 1 wherein the electronic device is selected from one of: a desktop computer, a smart phone, a laptop computer, and a tablet computer.

12. A system comprising:
a server having a processor and connected to a network interface device and
a memory, wherein the processor is configured to:
maintain, in the memory, a first database with a plurality of content items, each content item associated with one or more contribution factors and a quality score;
maintain, in the memory, a second database with a plurality of learning records, each learning record corresponding to an achievement profile of a learner;
receive, from an electronic device, an electronic request for a selection of content items for a learner;
filter the plurality of content items based on the one or more contribution factors and the quality score;
send the selected, filtered content items to the electronic device for presentation on a display of the electronic device;
receive, from the electronic device, input associated with the selected, filtered and displayed content items; and
adjust the quality score associated with the content item, responsive to the received input.

13. The system of claim 12 wherein the electronic device is selected from one of: a desktop computer, a smart phone, a laptop computer, and a tablet computer.
